(19) United States
(12) Patent Application Publication
(10) Pub. No.: US 2024/0119603 A1
(43) Pub. Date: Apr. 11, 2024

(54) BALL TRACKING SYSTEM AND METHOD

(71) Applicant: INSTITUTE FOR INFORMATION INDUSTRY, TAIPEI (TW)

(72) Inventors: Rong-Sheng WANG, Taipei (TW); Shih-Chun CHOU, Taipei (TW); Hsiao-Chen CHANG, Taipei (TW)

(21) Appl. No.: 18/056,260

(22) Filed: Nov. 17, 2022

(30) Foreign Application Priority Data
Oct. 6, 2022 (TW) 111138080

(51) Int. Cl. G06T 7/20; G06T 7/60; G06T 7/70; G06V 20/40

(52) U.S. Cl. CPC G06T 7/20; G06T 7/60; G06T 7/70; G06V 20/41; G06T 2207/10016; G06T 2207/30196; G06T 2207/30224; G06T 2207/30228; G06T 2207/30241

(57) ABSTRACT

The present disclosure provides a ball tracking system and method. The ball tracking system includes camera device and processing device. The camera device is configured to generate a plurality of video frame data, wherein the video frame data includes image of ball. The processing device is electrically coupled to the camera device and is configured to: recognize the image of the ball from the plurality of video frame data to obtain 2D estimation coordinate of the ball at first frame time and utilize 2D to 3D matrix to convert the 2D estimation coordinate into first 3D estimation coordinate; utilize model to calculate second 3D estimation coordinate of the ball at the first frame time; and calibrate according to the first 3D estimation coordinate and the second 3D estimation coordinate to generate 3D calibration coordinate of the ball at the first frame time.

### CROSS-REFERENCE TO RELATED APPLICATION

This application claims priority to Taiwan Application Serial Number 111138080, filed Oct. 6, 2022, which is herein incorporated by reference in its entirety.

### BACKGROUND

### Field of Invention

This disclosure relates to a ball tracking system and method, and in particular to a ball tracking system and method applied to net sports.

### Description of Related Art

The existing Hawk-Eye systems used by many official games require arrangement of multiple high speed cameras in multiple locations of the game field. Even the ball trajectory detection systems for non-official game use also require at least two cameras and computer capable of taking heavy computational load. It can be seen from these that the above systems are costly and difficult to obtain, which disadvantages their implementation in the daily use of the general public.

### SUMMARY

An aspect of present disclosure relates to a ball tracking system. The ball tracking system includes a camera device and a processing device. The camera device is configured to generate a plurality of video frame data, wherein the plurality of video frame data includes an image of a ball. The processing device is electrically coupled to the camera device and is configured to: recognize the image of the ball from the plurality of video frame data to obtain a 2D (two-dimensional) estimation coordinate of the ball at a first frame time and utilize a 2D to 3D (three-dimensional) matrix to convert the 2D estimation coordinate into a first 3D estimation coordinate; utilize a model to calculate a second 3D estimation coordinate of the ball at the first frame time; and calibrate according to the first 3D estimation coordinate and the second 3D estimation coordinate to generate a 3D calibration coordinate of the ball at the first frame time.

Another aspect of present disclosure relates to a ball tracking method. The ball tracking method includes: capturing a plurality of video frame data, wherein the plurality of video frame data includes an image of a ball; recognizing the image of the ball from the plurality of video frame data to obtain a 2D (two-dimensional) estimation coordinate of the ball at a first frame time and utilizing a 2D to 3D (three-dimensional) matrix to convert the 2D estimation coordinate into a first 3D estimation coordinate; utilizing a model to calculate a second 3D estimation coordinate of the ball at the first frame time; and calibrating according to the first 3D estimation coordinate and the second 3D estimation coordinate to generate a 3D calibration coordinate of the ball at the first frame time.

### BRIEF DESCRIPTION OF THE DRAWINGS

FIG. 1 is a block diagram of a ball tracking system in accordance with some embodiments of the present disclosure;

FIG. 2 is a block diagram of a ball tracking system in accordance with some embodiments of the present disclosure;

FIG. 3 is a schematic diagram of an application of the ball tracking system to a net sport in accordance with some embodiments of the present disclosure;

FIG. 4 is a flow diagram of a ball tracking method in accordance with some embodiments of the present disclosure;

FIG. 5 is a schematic diagram of a frame corresponding to a frame time in accordance with some embodiments of the present disclosure;

FIG. 6 is a schematic diagram of a key frame corresponding to a key frame time in accordance with some embodiments of the present disclosure;

FIG. 7 is a flow diagram of one step of the ball tracking method in accordance with some embodiments of the present disclosure;

FIG. 8 is a schematic diagram of another frame corresponding to another frame time in accordance with some embodiments of the present disclosure;

FIG. 9 is a flow diagram of a ball tracking method in accordance with some embodiments of the present disclosure;

FIG. 10 is a schematic diagram of a reference video frame data in accordance with some embodiments of the present disclosure;

FIG. 11 is a flow diagram of a ball tracking method in accordance with some embodiments of the present disclosure; and

FIG. 12 is a flow diagram of a ball tracking method in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

The terms “ball” as used herein may mean an object which is used in any form of ball games or ball sports and is featured as main part of play. It can be selected from a group including shuttlecock, tennis ball, table tennis ball, volleyball, baseball, cricket, American football, soccer, rugby, hockey, lacrosse, bowling, and golf.

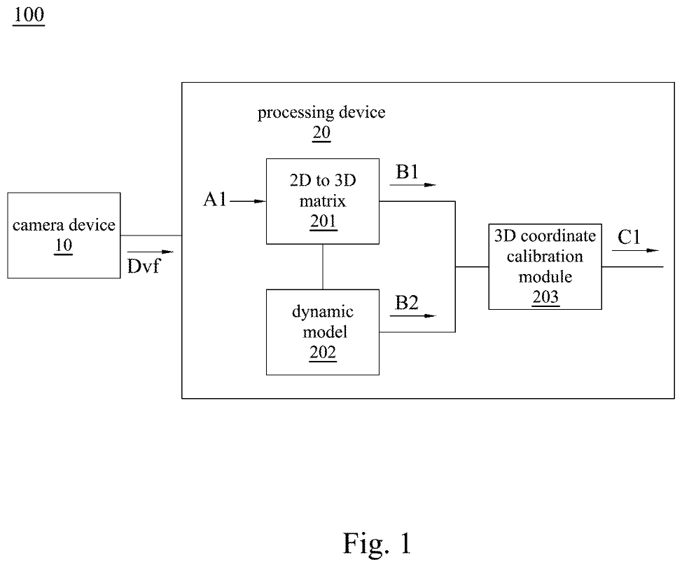

Referring to FIG. 1, FIG. 1 is a block diagram of a ball tracking system 100 in accordance with some embodiments of the present disclosure. In some embodiments, the ball tracking system 100 includes a camera device 10 and a processing device 20. In particular, the camera device 10 is implemented by a camera having a single lens, and the processing device 20 is implemented by a central processing unit (CPU), an application-specific integrated circuit (ASIC), a microprocessor, a system on a Chip (SoC) or other circuits or components having data access, data calculation, data store, data transmission or similar functions.

In some embodiments, the ball tracking system 100 is applied to a net sport (e.g., badminton, tennis, table tennis, volleyball, etc.) and is configured to track a ball used for the net sport (e.g., shuttlecock, tennis ball, table tennis ball, volleyball, etc). As shown in FIG. 1, the camera device 10 is electrically coupled to the processing device 20. In some practical applications, the camera device 10 is arranged on a surround of a field used for the net sport, and the processing device 20 is a computer or a server independent from the camera device 10 and can communicate with the camera device 10 in a wireless manner. In other practical applications, the camera device 10 and the processing device 20 are integrated as a single device, and the single device is arranged on the surround of the field used for the net sport.

In an operation of the ball tracking system 100, the camera device 10 is configured to shoot to generate a plurality of video frame data Dvf, wherein the video frame data Dvf includes an image of a ball (not shown in FIG. 1). It can be appreciated that the net sport usually performed by at least two athletes on the field having a net. Accordingly, in some embodiments, the video frame data Dvf further includes images of at least two athletes and an image of the field. In the plurality of video frame data Dvf, the ball in part of the video frame data Dvf might be obscured since the athlete would move or hit the ball.

In the embodiments of FIG. 1, the processing device 20 is configured to receive the video frame data Dvf from the camera device 10. In these embodiments, it can be appreciated that the video frame data Dvf generated by the camera device 10 with the single lens can only provide two-dimensional information instead of providing three-dimensional information. Accordingly, as shown in FIG. 1, the processing device 20 includes a 2D (two-dimensional) to 3D (three-dimensional) matrix 201, a dynamic model 202 and a 3D coordinate calibration module 203, to obtain the three-dimensional information related to the ball according to the video frame data Dvf.

In particular, the processing device 20 recognizes the image of the ball from the video frame data Dvf, to obtain a 2D estimation coordinate A1 of the ball at a certain frame time. Then, the processing device 20 utilizes the 2D to 3D matrix 201 to convert the 2D estimation coordinate A1 into a first 3D estimation coordinate B1 and also utilizes the dynamic model 202 to calculate a second 3D estimation coordinate B2 of the ball at said certain frame time. Finally, the processing device 20 utilizes the 3D coordinate calibration module 203 to calibrate according to the first 3D estimation coordinate B1 and the second 3D estimation coordinate B2, to generate a 3D calibration coordinate C1 of the ball at said certain frame time. By analogy, the ball tracking system 100 can calculate the 3D calibration coordinate C1 of the ball at each frame time, so as to build a 3D flight trajectory of the ball and further analyze the net sport according to the 3D flight trajectory of the ball thereafter.

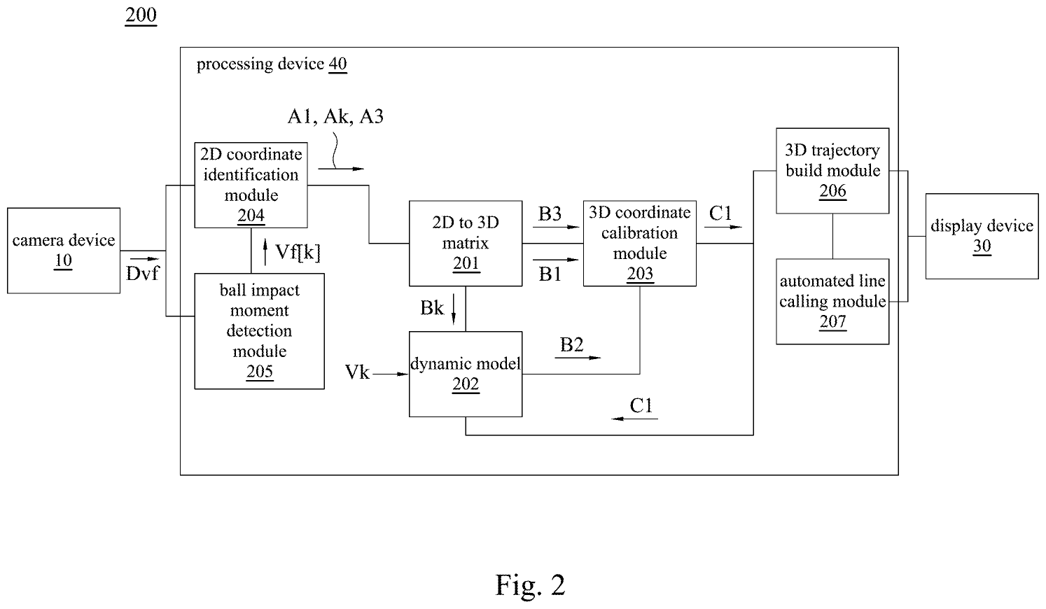

It can be appreciated that the ball tracking system of the present disclosure is not limited to the structure as shown in FIG. 1. For example, referring to FIG. 2, FIG. 2 is a block diagram of a ball tracking system 200 in accordance with some embodiments of the present disclosure. In the embodiments of FIG. 2, the ball tracking system 200 includes the camera device 10 as shown in FIG. 1, a processing device 40 and a display device 30. It can be appreciated that the processing device 40 in FIG. 2 is similar but different from the processing device 20 in FIG. 1. For example, in addition to the 2D to 3D matrix 201, the dynamic model 202 and the 3D coordinate calibration module 203, the processing device 40 further includes a 2D coordinate identification module 204, a ball impact moment detection module 205, a 3D trajectory build module 206 and an automated line calling module 207.

As shown in FIG. 2, the processing device 40 is electrically coupled between the camera device 10 and the display device 30. In some practical applications, the camera device 10 and the display device 30 are arranged on the surround of the field used for the net sport, and the processing device 40 is a server independent from the camera device 10 and the display device 30 and can communicate with the camera device 10 and the display device 30 in a wireless manner. In other practical applications, the camera device 10 and the processing device 40 are integrated as a single device, and the single device is arranged on the surround of the field used for the net sport. In other practical applications, the camera device 10 and the display device 30 are arranged on the surround of the field used for the net sport, and the processing device 40 is integrated into one of the camera device 10 and the display device 30. In yet other practical applications, the camera device 10, the processing device 40 and the display device 30 are integrated as a single device, and the single device is arranged on the surround of the field used for the net sport.

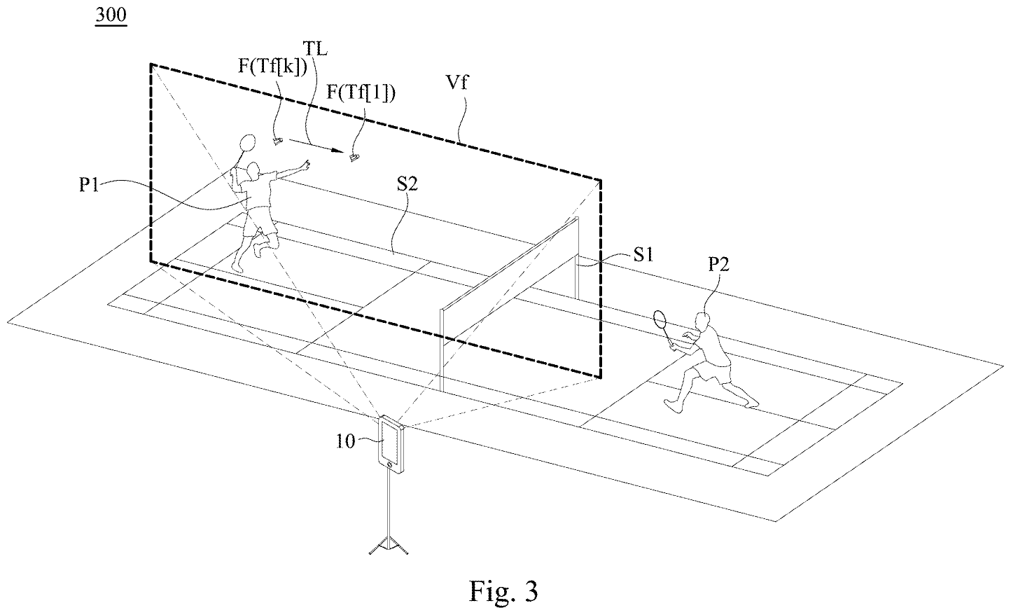

Referring to FIG. 3 together, FIG. 3 is a schematic diagram of an application of the ball tracking system to a net sport 300 in accordance with some embodiments of the present disclosure. In some embodiments, the net sport 300 is a badminton sport and is performed by two athletes P1 and P2. As shown in FIG. 3, a net (which is held by two net-posts S1) separates a court S2 into two regions for the two athletes P1 and P2 to play with a ball F, and the ball F is a shuttlecock hit by the athletes P1 or P2 in these embodiments. The camera device 10 is a smartphone (which can be provided by one of the two athletes P1 and P2) and is arranged on the surround of the court S2. It can be appreciated that the display device 30 of FIG. 2 can also be arranged on the surround of the court S2. However, the display device 30 is not shown in FIG. 3 for simplifying descriptions.

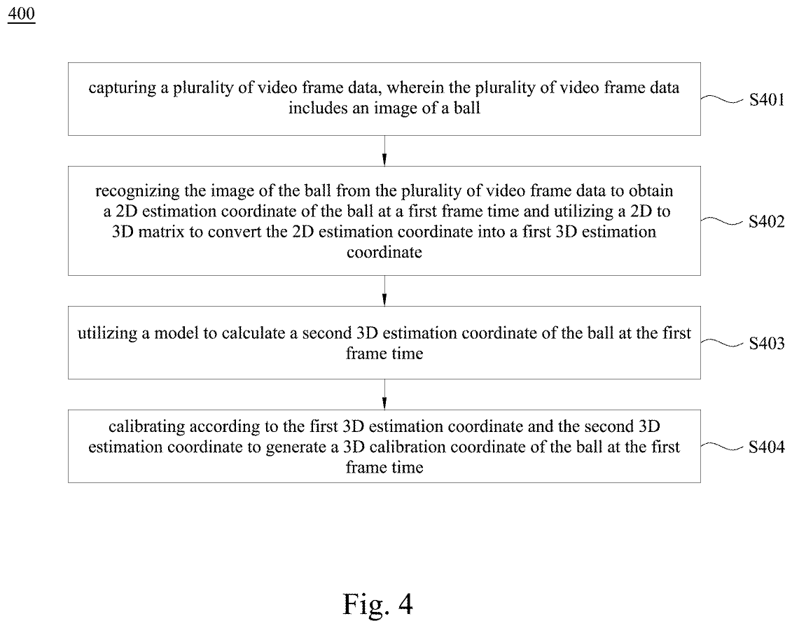

The operation of the ball tracking system 200 would be described in detail below with reference to FIG. 4. Referring to FIG. 4, FIG. 4 is a flow diagram of a ball tracking method 400 in accordance with some embodiments of the present disclosure. In some embodiments, the ball tracking method 400 includes steps S401-S404 and can be executed by the ball tracking system 200. However, the present disclosure is not limited herein. The ball tracking method 400 can also be executed by the ball tracking system 100 of FIG. 1.

In step S401, as shown in FIG. 3, the camera device 10 on the surround of the court S2 shoots the net sport 300 and captures the video frame data Dvf (as shown in FIG. 2) related to the net sport 300. Accordingly, in some embodiments, the video frame data Dvf includes a plurality of two-dimensional frames Vf (which is represented by broken lines) as shown in FIG. 3.

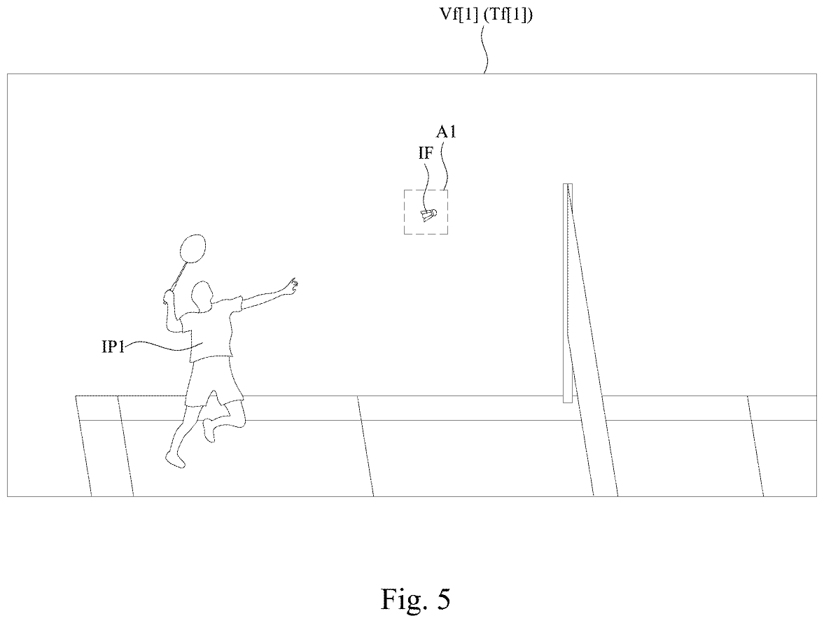

In step S402, the processing device 40 recognizes the image of the ball F from the video frame data Dvf to obtain the 2D estimation coordinate A1 of the ball F at a frame time Tf[1] and utilizes the 2D to 3D matrix 201 to convert the 2D estimation coordinate A1 into the first 3D estimation coordinate B1. The step S402 would be described in detail below with reference to FIG. 5. Referring to FIG. 5, FIG. 5 is a schematic diagram of a frame Vf[1] corresponding to the frame time Tf[1] in accordance with some embodiments of the present disclosure. As shown in FIG. 5, the frame Vf[1] includes an athlete image IP1 of the athlete P1 and a ball image IF of the ball F. In some embodiments, the ball F is a shuttlecock, and the ball image IF includes a shuttlecock image.

Generally speaking, the ball F in the net sport 300 is a small object, its flight speed might exceed 400 km/h, and the size of the ball image IF might be 10 pixels. Therefore, the ball image IF might be deformed, blurred and/or distorted in the frame Vf[1] due to the high flight speed of the ball F. Also, the ball image IF might almost disappear in the frame Vf[1] because the ball F has a similar color to other objects. Accordingly, in some embodiments, the processing device 40 utilizes the 2D coordinate identification module 204 to recognize the ball image IF from the frame Vf[1]. In particular, the 2D coordinate identification module 204 is implemented by a deep neural network (e.g., TrackNetV2). This deep neural network technique can overcome the problems of low image quality, such as blur, after-image, short-term occlusion, etc. Also, some continuous images can be inputted into this deep neural network technique for detecting the ball image IF. The operations of utilizing the deep neural network to recognize the ball image IF from the frame Vf[1] is well known to a person having ordinary skill in the art of the present disclosure, and therefore are omitted herein.

After recognizing the ball image IF, the processing device 40 can use a upper left pixel of the frame Vf[1] as an origin of coordinate by itself or by the 2D coordinate identification module 204 to build a 2D coordinate system, and can obtain the 2D estimation coordinate A1 of the ball image IF in the frame Vf[1] according to the position of the ball image IF in the frame Vf[1]. It can be appreciated that other suitable pixel (e.g., a upper right pixel, a lower left pixel or a lower right pixel) in the frame Vf[1] can also be used as the origin of coordinate.

Then, as shown in FIG. 2, the processing device 40 utilizes the 2D to 3D matrix 201 to convert the 2D estimation coordinate A1. In some embodiments, the 2D to 3D matrix 201 can be pre-established according to a proportion relationship of a two-dimensional size (which can be obtained by analyzing the images shot by the camera device 10) and a three-dimensional standard size (which can be obtained by referring to the standard field specification of the net sport 300) of at least one standard object. Accordingly, the 2D to 3D matrix 201 can be configured to calculate the first 3D estimation coordinate B1 of the ball F in a field 3D model (not shown) of the net sport 300 according to the 2D estimation coordinate A1 of the ball image IF in the frame Vf[1].

In some embodiments, according to the relative position of the camera device 10 and the net sport 300, some identifiable features (e.g., the highest point of the net-post S1, the intersection of at least two boundary lines on the court S2) of the net sport 300 can be shot and analyzed to be a reference for relative position comparison. Then, the field 3D model of the net sport 300 can be built accordingly by referring the actual size or distance between the identifiable features.

In some embodiments, even though the use of the 2D coordinate identification module 204 can dramatically increase the identification accuracy of the ball image IF, other similar images (e.g., the image of white shoe) might still be mistakenly recognized as the ball image IF due to the above problems of image deformation, blur, distortion and/or disappearance. Therefore, the first 3D estimation coordinate B1 obtained in step S402 might be not corresponding to the ball F. Accordingly, the ball tracking method 400 executes step S403 to calibrate.

In step S403, the processing device 40 utilizes a model to calculate the second 3D estimation coordinate B2 of the ball F at the frame time Tf[1]. In some embodiments, the model used in step S403 is the dynamic model 202 (as shown in FIG. 2) of shuttlecock (i.e., the ball F). In these embodiments, the dynamic model 202 can use an aerodynamic model of the shuttlecock because the flight trajectory of the shuttlecock can be easily affected by air and wind direction. In this model, the flight trajectory of the shuttlecock depends on some parameters, such as speed and angle of the shuttlecock at the hit moment, angular velocity of the shuttlecock, air resistance and gravitational acceleration that the shuttlecock encounters in flight, etc. In some embodiments, the processing device 40 considers all of the above parameters when calculating the flight trajectory of the shuttlecock, to calculate precise flight distance and direction. In some embodiments, the processing device 40 only considers the speed and angle of the shuttlecock at the hit moment and the air resistance and gravitational acceleration that the shuttlecock encounters in flight when calculating the flight trajectory of the shuttlecock, to reduce the computational load of the processing device 40 and popularize the ball tracking method 400. Generally speaking, the air resistance and gravitational acceleration that the shuttlecock encounters in flight can be regarded as constant. Accordingly, as shown in FIG. 2, the dynamic model 202 can easily and rapidly calculate the second 3D estimation coordinate B2 of the ball F according to a ball impact moment velocity Vk and a ball impact moment 3D coordinate Bk of the ball F.

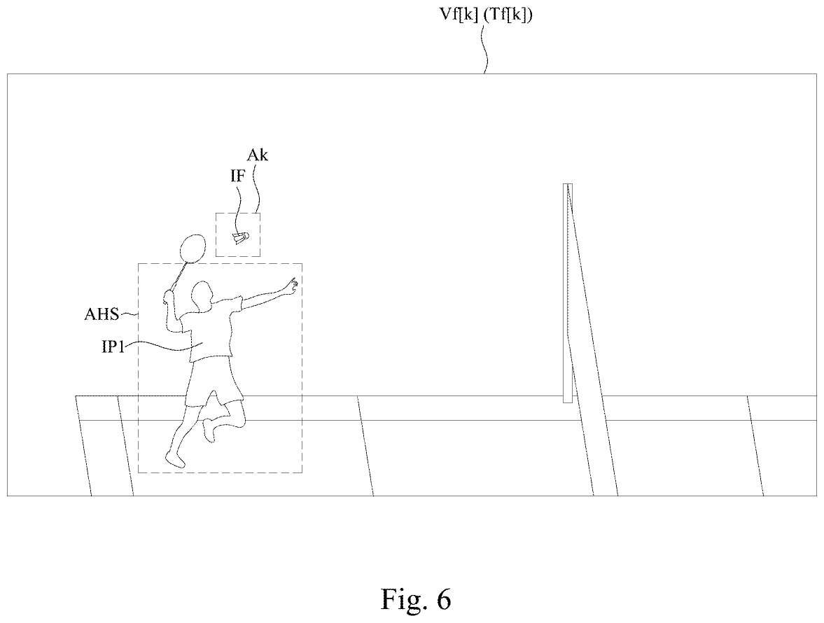

In some embodiments, as shown in FIG. 2, the processing device 40 utilizes the ball impact moment detection module 205 to detect a key frame Vf[k] in the video frame data Dvf, to calculate the ball impact moment velocity Vk and the ball impact moment 3D coordinate Bk of the ball F according to the key frame Vf[k]. Referring to FIG. 6, FIG. 6 is a schematic diagram of the key frame Vf[k] corresponding to a key frame time Tf[k] in accordance with some embodiments of the present disclosure. In some embodiments, the ball impact moment detection module 205 is trained through a training data (not shown) which is pre-prepared, to recognize a ball impact posture AHS of the athlete P1 from the video frame data Dvf. In particular, the training data includes a plurality of training images, and each training image corresponds to a first frame after the athlete hits the ball. In addition, the athlete image in each training image is marked, so that the ball impact moment detection module 205 can recognize the ball impact posture of the athlete correctly. When recognizing the ball impact posture AHS of the athlete P1 from the video frame data Dvf, the ball impact moment detection module 205 can use the frame in the video frame data Dvf corresponding to the ball impact posture AHS as the key frame Vf[k].

As shown in FIG. 2, the processing device 40 then utilizes the 2D coordinate identification module 204 again to recognize the ball image IF in the key frame Vf[k] and obtains a ball impact moment 2D coordinate Ak of the ball F in the key frame Vf[k] accordingly. Thereafter, the processing device 40 utilizes the 2D to 3D matrix 201 to convert the ball impact moment 2D coordinate Ak, to obtain the ball impact moment 3D coordinate Bk of the ball F in the field 3D model of the net sport 300.

In some embodiments, after obtaining the ball impact moment 3D coordinate Bk of the ball F, the processing device 40 is further configured to obtain continuous frames (e.g., 3-5 frames) or a certain frame after the key frame Vf[k] from the video frame data Dvf, to calculate the ball impact moment velocity Vk of the ball F. For example, the processing device 40 can obtain at least one frame between the key frame Vf[k] and the frame Vf[1] and utilize the 2D coordinate identification module 204 and the 2D to 3D matrix 201 to obtain a corresponding 3D estimation coordinate. In other words, the processing device 40 calculates the 3D estimation coordinate of the ball F at a certain frame time after the key frame time Tf[k]. Then, the processing device 40 can divide a moving difference of the 3D estimation coordinate of said certain frame time and the ball impact moment 3D coordinate Bk by a time difference of said certain frame time and the key frame time Tf[k], to calculate the ball impact moment velocity Vk of the ball F. In addition, the processing device 40 can also calculate multiple 3D estimation coordinates of the ball F corresponding to continuous frame times after the key frame time Tf[k]. Then, a plurality of moving differences are calculated by subtracting the ball impact moment 3D coordinate Bk from the multiple 3D estimation coordinates of said continuous frame times, a plurality of time differences are calculated by subtracting the key frame time Tf[k] from said continuous frame times, and the plurality of moving differences are divided by the plurality of time differences to obtain a minimal value therefrom as the ball impact moment velocity Vk of the ball F, which can further confirm the ball impact moment velocity Vk of the ball F. It can be seen from these that the processing device 40 is configured to calculate the ball impact moment velocity Vk of the ball F according to the key frame Vf[k] and at least one frame after the key frame Vf[k].

In some embodiments, as shown in FIG. 2, after obtaining the ball impact moment velocity Vk and the ball impact moment 3D coordinate Bk of the ball F, the processing device 40 is configured to input the ball impact moment velocity Vk and the ball impact moment 3D coordinate Bk into the dynamic model 202, to calculate the second 3D estimation coordinate B2 of the ball F at the frame time Tf[1].

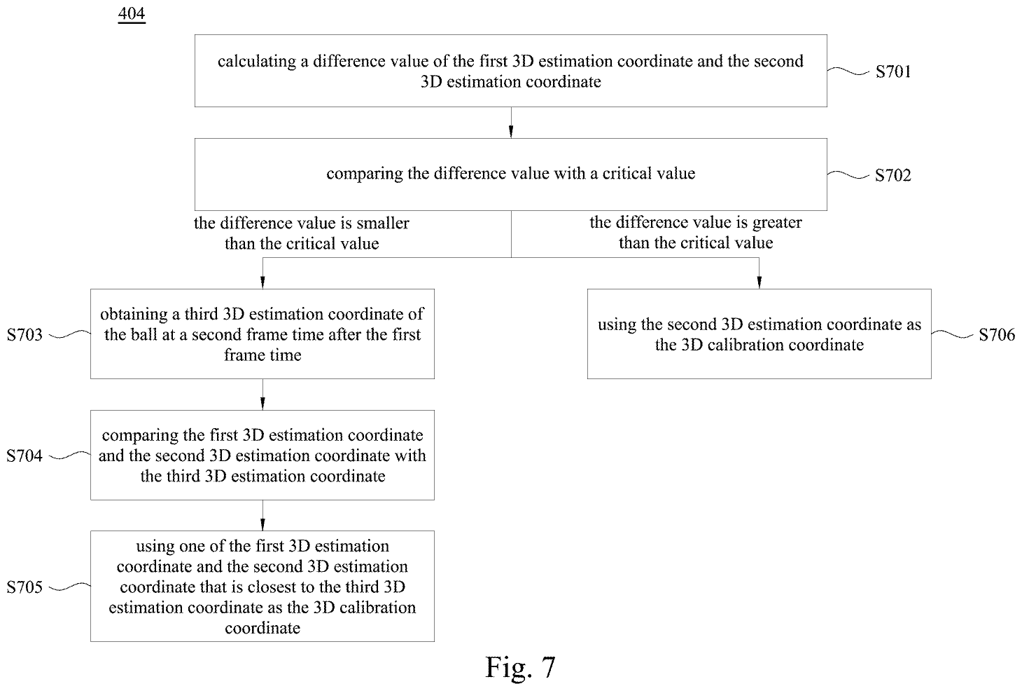

In step S404, the processing device 40 calibrates according to the first 3D estimation coordinate B1 and the second 3D estimation coordinate B2 to generate the 3D calibration coordinate C1 of the ball F at the frame time Tf[1]. In some embodiments, as shown in FIG. 2, the processing device 40 utilizes the 3D coordinate calibration module 203 to calibrate. The step S404 would be described in detail below with reference to FIG. 7. Referring to FIG. 7, FIG. 7 is a flow diagram of step S404 in accordance with some embodiments of the present disclosure. In some embodiments, as shown in FIG. 7, step S404 includes sub-steps S701-S706, but the present disclosure is not limited herein.

In sub-step S701, the 3D coordinate calibration module 203 calculates a difference value of the first 3D estimation coordinate B1 and the second 3D estimation coordinate B2. For example, the 3D coordinate calibration module 203 can use a three-dimensional Euclidean distance formula to calculate the difference value of the first 3D estimation coordinate B1 and the second 3D estimation coordinate B2.

In sub-step S702, the 3D coordinate calibration module 203 compares the difference value calculated in sub-step S701 with a critical value.

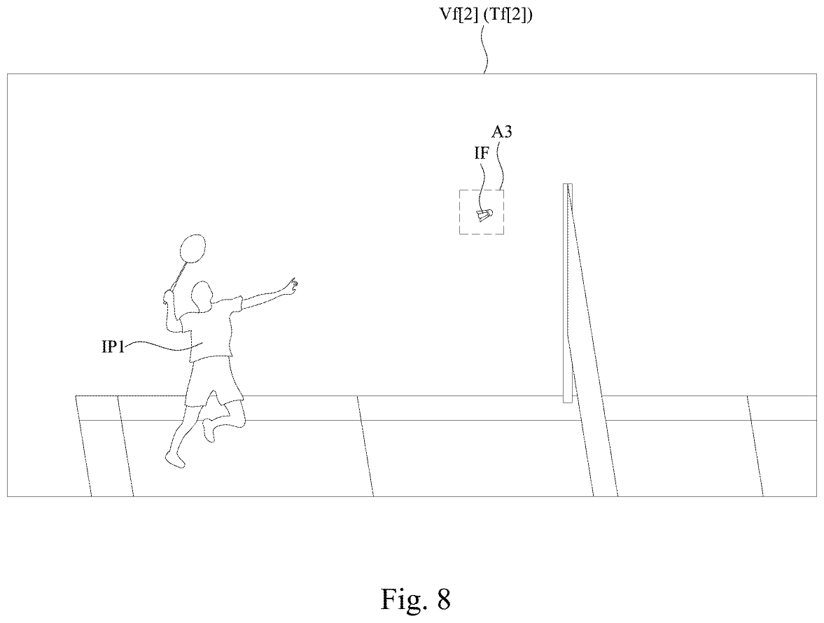

In some embodiments, when the difference value is smaller than the critical value, it presents that the first 3D estimation coordinate B1 might correctly correspond to the ball F, so that step S703 is executed. In step S703, the processing device 40 obtains a third 3D estimation coordinate B3 (as shown in FIG. 2) of the ball F at a frame time Tf[2] after the frame time Tf[1]. In particular, the frame time Tf[2] is next to the frame time Tf[1]. Referring to FIG. 8, FIG. 8 is a schematic diagram of a frame Vf[2] corresponding to the frame time Tf[2] in accordance with some embodiments of the present disclosure. As shown in FIGS. 2 and 8, the processing device 40 utilizes the 2D coordinate identification module 204 to obtain a 2D estimation coordinate A3 of the ball F in the frame Vf[2] and utilizes the 2D to 3D matrix 201 to convert the 2D estimation coordinate A3 into the third 3D estimation coordinate B3 in the field 3D model of the net sport 300. The calculation of the third 3D estimation coordinate B3 is similar to the calculation of the first 3D estimation coordinate B1, and therefore are omitted herein.

In sub-step S704, the 3D coordinate calibration module 203 compares the first 3D estimation coordinate B1 and the second 3D estimation coordinate B2 with the third 3D estimation coordinate B3, respectively. In sub-step S705, the 3D coordinate calibration module 203 uses one of the first 3D estimation coordinate B1 and the second 3D estimation coordinate B2 that is closest to the third 3D estimation coordinate B3 as the 3D calibration coordinate C1. For example, the 3D coordinate calibration module 203 calculates a first difference value of the first 3D estimation coordinate B1 and the third 3D estimation coordinate B3, calculates a second difference value of the second 3D estimation coordinate B2 and the third 3D estimation coordinate B3 and compares the first difference value and the second difference value with each other, so as to find the one closest to the third 3D estimation coordinate B3. It can be appreciated that the first difference value and the second difference value can be calculated through the three-dimensional Euclidean distance formula. When the first difference value is smaller than the second difference value, the 3D coordinate calibration module 203 uses the first 3D estimation coordinate B1 as the 3D calibration coordinate C1. When the first difference value is greater than the second difference value, the 3D coordinate calibration module 203 uses the second 3D estimation coordinate B2 as the 3D calibration coordinate C1.

Generally speaking, a difference between two 3D estimation coordinates corresponding to two continuous frame times (i.e., the frame time Tf[1] and the frame time Tf[2]) should be extremely small. Therefore, as above descriptions, when a difference between the first 3D estimation coordinate B1 and the second 3D estimation coordinate B2 of the ball F at the frame time Tf[1] is little, by sub-steps S703-S705, the processing device 40 would choose the one which is close to the third 3D estimation coordinate B3 of the ball F at the next frame time Tf[2] as the 3D calibration coordinate C1.

As shown in FIG. 7, in some embodiments, when the difference value is greater than the critical value, it represents that the first 3D estimation coordinate B1 might not correspond to the ball F, so that step S706 is executed. In sub-step S706, the 3D coordinate calibration module 203 would use the second 3D estimation coordinate B2 as the 3D calibration coordinate C1. In other words, when the difference between the first 3D estimation coordinate B1 and the second 3D estimation coordinate B2 is big, by sub-step S706, the processing device 40 can avoid using the first 3D estimation coordinate B1 which might not correspond to the ball F as the 3D calibration coordinate C1.

As can be seen from above descriptions, by using the second 3D estimation coordinate B2 calculated through the dynamic model 202 to calibrate the first 3D estimation coordinate B1 obtained by image recognition, the ball tracking system and method of the present disclosure can dramatically decrease the problems of mistakenly recognizing the ball image IF due to the image deformation, blur, distortion and/or disappearance, so as to make the 3D calibration coordinate C1 of the ball F precise.

In the above embodiments, as shown in FIG. 2, the dynamic model 202 can receive the 3D calibration coordinate C1 of the ball F at the frame time Tf[1] from the 3D coordinate calibration module 203 as an initial coordinate data, so as to calculate the second 3D estimation coordinate B2 of the ball F after the frame time Tf[1]. By using the 3D calibration coordinate C1 as the initial coordinate data, the second 3D estimation coordinate B2 which is calculated would be precise.

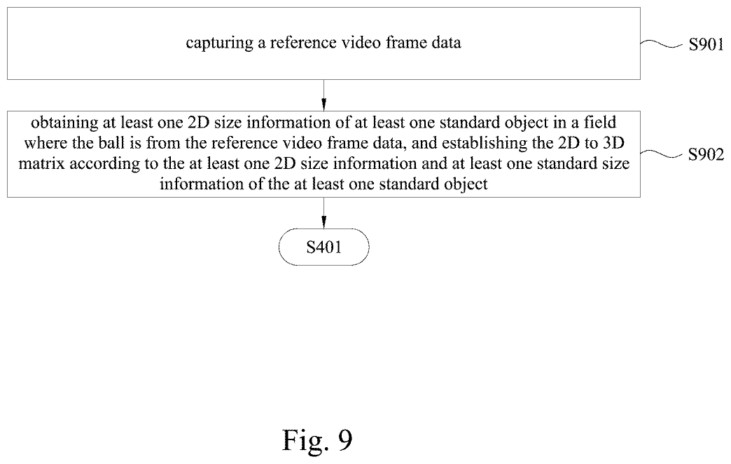

It can be appreciated that the ball tracking method 400 of FIG. 4 is merely an example and is not intended to limit the present disclosure. The embodiments of FIGS. 9 and 11-12 would be taken as example below for further descriptions.

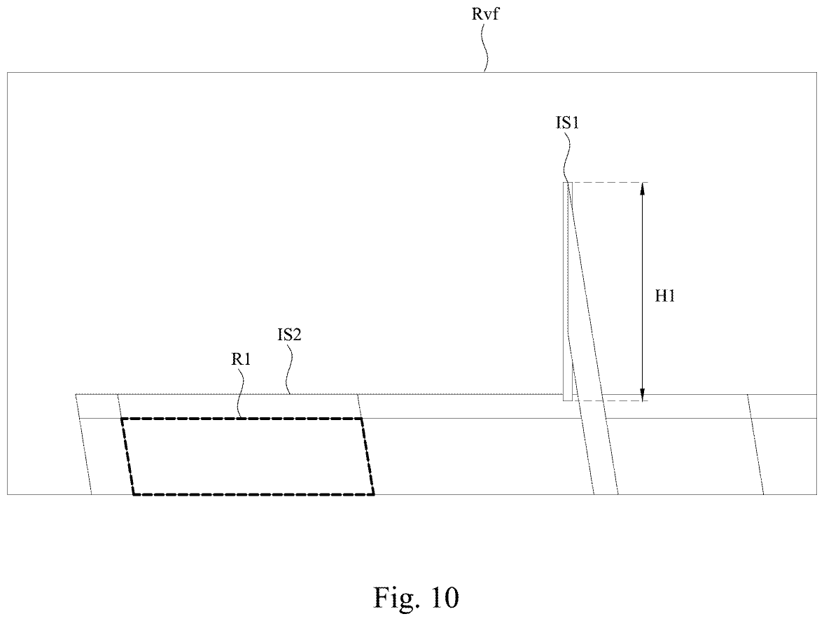

Referring to FIG. 9, FIG. 9 is a flow diagram of the ball tracking method in accordance with some embodiments of the present disclosure. In some embodiments, before step S401, the ball tracking method of the present disclosure further includes steps S901-S902. In step S901, the camera device 10 captures a reference video frame data Rvf. Referring to FIG. 10 together, FIG. 10 is a schematic diagram of the reference video frame data Rvf in accordance with some embodiments of the present disclosure. In some embodiments, the reference video frame data Rvf is obtained before the net sport is performed. Therefore, as shown in FIG. 10, the reference video frame data Rvf includes a net-post image IS1 corresponding to the net-post S1 and a court image IS2 corresponding to the court S2, but does not include the images of the athlete P1, the ball F and/or the athlete P2.

In step S902, the processing device 40 obtains at least one 2D size information of at least one standard object in the field where the ball F is from the reference video frame data Rvf, and establishes the 2D to 3D matrix 201 according to the at least one 2D size information and at least one standard size information of the at least one standard object. For example, as shown in FIG. 10, the processing device 40 recognizes the net-post image IS1 and a left service court R1 in the court image IS2 from the reference video frame data Rvf. The processing device 40 calculates a 2D height H1 of the net-post image IS1 corresponding to a 3D height direction according to pixels of the net-post image IS1 and calculates a 2D length and a 2D width of the left service court R1 corresponding to a 3D length direction and a 3D width direction according to pixels of the left service court R1. Then, the processing device 40 calculates a height proportion relationship according to the 2D height H1 and a standard height (e.g., 1.55 m) of the net-post S1 regulated in the net sport, calculates a length proportion relationship according to the 2D length and a standard length of the left service court R1 regulated in the net sport, and calculates a width proportion relationship according to the 2D width and a standard width of the left service court R1 regulated in the net sport. Finally, the processing device 40 calculates according to the height proportion relationship, the length proportion relationship and the width proportion relationship to establish the 2D to 3D matrix 201.

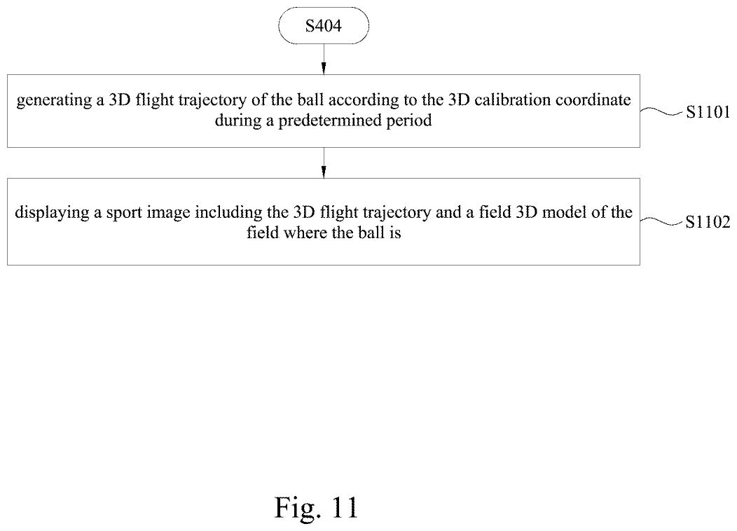

Referring to FIG. 11, FIG. 11 is a flow diagram of the ball tracking method in accordance with some embodiments of the present disclosure. In some embodiments, after step S404, the ball tracking method of the present disclosure further includes steps S1101-S1102. In step S1101, the processing device 40 utilizes the 3D trajectory build module 206 (as shown in FIG. 2) to generate a 3D flight trajectory of the ball F according to the 3D calibration coordinate C1 during a predetermined period. Although the 3D flight trajectory of the ball F is not illustrated in the drawings, it can be appreciated that step S1101 is used for simulating the flight trajectory TL as shown in FIG. 2 according to multiple 3D calibration coordinates C1 during the predetermined period (e.g., from the key frame time Tf[k] to the frame time Tf[1]). In step S1102, the display device 30 displays a sport image (not shown) including the 3D flight trajectory and the field 3D model of the field where the ball F is. In such way, even though the related personnel (e.g., the athletes P1 and P2, audience, judge, etc.) cannot see the ball F clearly because the ball F is too fast, by step S1102, the related personnel can clearly know the flight trajectory TL of the ball F through the 3D flight trajectory and the field 3D model which are simulated.

As above descriptions, in some embodiments, in addition to the 3D flight trajectory and the field 3D model which are simulated, the sport image displayed by the display device 30 includes the image shot by the camera device 10.

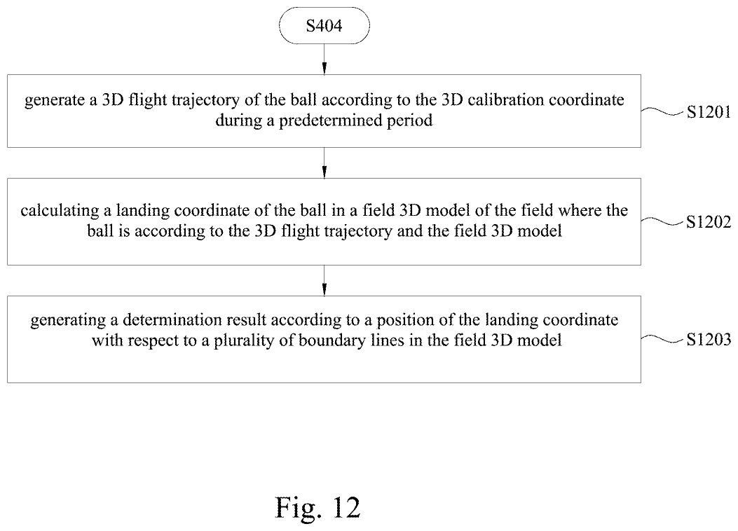

Referring to FIG. 12, FIG. 12 is a flow diagram of the ball tracking method in accordance with some embodiments of the present disclosure. In some embodiments, after step S404, the ball tracking method of the present disclosure further includes steps S1201-S1203. In step S1201, the processing device 40 utilizes the 3D trajectory build module 206 to generate the 3D flight trajectory of the ball F according to the 3D calibration coordinate C1 during the predetermined period. The operation of step S1201 is same or similar to those of step S1101, and therefore is omitted herein.

In step S1202, the processing device 40 utilizes the automated line calling module 207 (as shown in FIG. 2) to calculate a landing coordinate (not shown) of the ball F in the field 3D model of the field where the ball F is according to the 3D flight trajectory and the field 3D model. In some embodiments, the automated line calling module 207 uses a point at which the 3D flight trajectory and a reference horizontal plane (not shown) in the field 3D model corresponding to the ground are intersected as the landing point of the ball F and calculates the landing coordinate corresponding thereto.

In step S1203, the processing device 40 utilizes the automated line calling module 207 to generate a determination result according to a position of the landing coordinate with respect to a plurality of boundary lines in the field 3D model. In particular, the automated line calling module 207 can determine whether the ball F is inside or outside the bound according to the rules of the net sport 300 and the position of the landing coordinate with respect to the boundary lines in the field 3D model. In some embodiments, the display device 30 of FIG. 2 can receive the determination result from the automated line calling module 207 and displays the determination result to the related personnel.

As can be seen from the above embodiments of the present disclosure, by using the camera device with the single lens and the processing device, the present disclosure can track the ball, can re-build the 3D flight trajectory of the ball and can help to determine whether the ball is inside or outside the bound. In such way, the user only needs to use the cell phone or general web camera to implement. In sum, the ball tracking system and method of the present disclosure has the advantage of low cost and ease of implementation.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A ball tracking system, comprising:
a camera device configured to generate a plurality of video frame data, wherein the plurality of video frame data comprises an image of a ball; and
a processing device electrically coupled to the camera device and configured to:
recognize the image of the ball from the plurality of video frame data to obtain a 2D (two-dimensional) estimation coordinate of the ball at a first frame time and utilize a 2D to 3D (three-dimensional) matrix to convert the 2D estimation coordinate into a first 3D estimation coordinate;
utilize a model to calculate a second 3D estimation coordinate of the ball at the first frame time; and
calibrate according to the first 3D estimation coordinate and the second 3D estimation coordinate to generate a 3D calibration coordinate of the ball at the first frame time.

2. The ball tracking system of claim 1, wherein the processing device is configured to obtain at least one 2D size information of at least one standard object in a field where the ball is from a reference video frame data, and is configured to establish the 2D to 3D matrix according to the at least one 2D size information and at least one standard size information of the at least one standard object.

3. The ball tracking system of claim 1, wherein the ball is used for a net sport and is selected from a group comprising a shuttlecock, a tennis ball, a table tennis ball and a volleyball, and the model is a dynamic model of the ball.

4. The ball tracking system of claim 3, wherein the plurality of video frame data comprises a key frame, and the processing device is configured to calculate a ball impact moment velocity and a ball impact moment 3D coordinate of the ball according to the key frame and is configured to input the ball impact moment velocity and the ball impact moment 3D coordinate into the model to calculate the second 3D estimation coordinate of the ball.

5. The ball tracking system of claim 4, wherein the processing device is configured to utilize a ball impact moment detection module to recognize a ball impact posture of an athlete from the plurality of video frame data to obtain the key frame.

6. The ball tracking system of claim 4, wherein the processing device is configured to convert a ball impact moment 2D coordinate of the ball in the key frame into the ball impact moment 3D coordinate and is configured to calculate the ball impact moment velocity of the ball according to the key frame and at least one frame after the key frame.

7. The ball tracking system of claim 1, wherein the processing device is configured to calculate a difference value of the first 3D estimation coordinate and the second 3D estimation coordinate and is configured to compare the difference value with a critical value;
wherein when the difference value is smaller than the critical value, the processing device is configured to obtain a third 3D estimation coordinate of the ball at a second frame time after the first frame time, is configured to compare the first 3D estimation coordinate and the second 3D estimation coordinate with the third 3D estimation coordinate, and is configured to use one of the first 3D estimation coordinate and the second 3D estimation coordinate that is closest to the third 3D estimation coordinate as the 3D calibration coordinate.

8. The ball tracking system of claim 1, wherein the processing device is configured to calculate a difference value of the first 3D estimation coordinate and the second 3D estimation coordinate and is configured to compare the difference value with a critical value;
wherein when the difference value is greater than the critical value, the processing device is configured to use the second 3D estimation coordinate as the 3D calibration coordinate.

9. The ball tracking system of claim 1, further comprising:
a display device electrically coupled to the processing device and configured to display an image comprising a 3D flight trajectory of the ball, wherein the 3D flight trajectory is generated according to the 3D calibration coordinate during a predetermined period by the processing device.

10. The ball tracking system of claim 1, wherein the processing device is configured to generate a 3D flight trajectory of the ball according to the 3D calibration coordinate during a predetermined period, is configured to calculate a landing coordinate of the ball in a field 3D model of a field where the ball is according to the 3D flight trajectory and the field 3D model, and is configured to generate a determination result according to a position of the landing coordinate with respect to a plurality of boundary lines in the field 3D model.

11. A ball tracking method, comprising:
capturing a plurality of video frame data, wherein the plurality of video frame data comprises an image of a ball;
recognizing the image of the ball from the plurality of video frame data to obtain a 2D (two-dimensional) estimation coordinate of the ball at a first frame time and utilizing a 2D to 3D (three-dimensional) matrix to convert the 2D estimation coordinate into a first 3D estimation coordinate;
utilizing a model to calculate a second 3D estimation coordinate of the ball at the first frame time; and
calibrating according to the first 3D estimation coordinate and the second 3D estimation coordinate to generate a 3D calibration coordinate of the ball at the first frame time.

12. The ball tracking method of claim 11, further comprising:
capturing a reference video frame data; and
obtaining at least one 2D size information of at least one standard object in a field where the ball is from the reference video frame data, and establishing the 2D to 3D matrix according to the at least one 2D size information and at least one standard size information of the at least one standard object.

13. The ball tracking method of claim 11, wherein the ball is used for a net sport and is selected from a group comprising a shuttlecock, a tennis ball, a table tennis ball and a volleyball, and the model is a dynamic model of the ball.

14. The ball tracking method of claim 13, further comprising:
calculating a ball impact moment velocity and a ball impact moment 3D coordinate of the ball according to a key frame of the plurality of video frame data; and
inputting the ball impact moment velocity and the ball impact moment 3D coordinate into the model to calculate the second 3D estimation coordinate of the ball.

15. The ball tracking method of claim 14, further comprising:
utilizing a ball impact moment detection module to recognize a ball impact posture of an athlete from the plurality of video frame data to obtain the key frame.

16. The ball tracking method of claim 14, wherein calculating the ball impact moment velocity and the ball impact moment 3D coordinate of the ball according to the key frame comprises:
converting a ball impact moment 2D coordinate of the ball in the key frame into the ball impact moment 3D coordinate; and
calculating the ball impact moment velocity of the ball according to the key frame and at least one frame after the key frame.

17. The ball tracking method of claim 11, wherein calibrating according to the first 3D estimation coordinate and the second 3D estimation coordinate to generate the 3D calibration coordinate of the ball at the first frame time comprises:
calculating a difference value of the first 3D estimation coordinate and the second 3D estimation coordinate;
comparing the difference value with a critical value; and
when the difference value is smaller than the critical value, obtaining a third 3D estimation coordinate of the ball at a second frame time after the first frame time, comparing the first 3D estimation coordinate and the second 3D estimation coordinate with the third 3D estimation coordinate, and using one of the first 3D estimation coordinate and the second 3D estimation coordinate that is closest to the third 3D estimation coordinate as the 3D calibration coordinate.

18. The ball tracking method of claim 11, wherein calibrating according to the first 3D estimation coordinate and the second 3D estimation coordinate to generate the 3D calibration coordinate of the ball at the first frame time comprises:
calculating a difference value of the first 3D estimation coordinate and the second 3D estimation coordinate;
comparing the difference value with a critical value; and
when the difference value is greater than the critical value, using the second 3D estimation coordinate as the 3D calibration coordinate.

19. The ball tracking method of claim 11, further comprising:
generating a 3D flight trajectory of the ball according to the 3D calibration coordinate during a predetermined period; and
displaying an image comprising the 3D flight trajectory.

20. The ball tracking method of claim 11, further comprising:
generating a 3D flight trajectory of the ball according to the 3D calibration coordinate during a predetermined period;
calculating a landing coordinate of the ball in a field 3D model of a field where the ball is according to the 3D flight trajectory and the field 3D model; and
generating a determination result according to a position of the landing coordinate with respect to a plurality of boundary lines in the field 3D model.
